(19) United States
(12) Patent Application Publication
(10) Pub. No.: US 2009/0240374 A1
(43) Pub. Date: Sep. 24, 2009

(54) METHOD OF CONTROLLING AIR CONDITIONER

(76) Inventors: Seung Youp Hyun, Seoul (KR); Deok Huh, Seoul (KR); Gil Bong Lee, Seoul (KR); Dong Won Sung, Seoul (KR)

Correspondence Address: KED & ASSOCIATES, LLP, P.O. Box 221200, Chantilly, VA, 20153-1200, US

(21) Appl. No.: 12/392,378

(22) Filed: Feb. 25, 2009

(30) Foreign Application Priority Data
Mar. 12, 2008 (KR) 10-2008-0022818

(51) Int. Cl. G05B 15/00

(52) U.S. Cl. 700/275

(57) ABSTRACT

A method of controlling an air conditioner is provided. The method may include determining whether the air conditioner is operating in an abnormal state, and, when the air conditioner is operating in the abnormal state, operating a compressor in a safe mode having a different frequency pattern than when it is operated in a normal mode of the compressor. This allows the air conditioner to provide continuous heating/cooling, even when operating in an abnormal state.

### CROSS-REFERENCE TO RELATED APPLICATIONS

This application claims priority under 35 U.S.C. 119 and 35 U.S.C. 365 to Korean Patent Application No. 10-2008-0022818 (filed in Korea on Mar. 12, 2008), which is hereby incorporated by reference in its entirety.

### BACKGROUND

1. Field

An air conditioning control system is provided.

2. Background

In general, an air conditioner is an apparatus for cooling or heating an interior space of a building. Such an air conditioner may include an indoor unit provided at an indoor space, and an outdoor unit provided at an outdoor space. The indoor and outdoor units may be may be separately installed at different sites, or may be provided integrally. The indoor unit may include an indoor heat exchanger, and the outdoor unit may include a compressor and an outdoor heat exchanger.

The compressor is an apparatus that compresses refrigerant. A temperature coming from the compressor may be varied according to a driving frequency of the compressor, so that the temperature of heat-exchanged air may also be varied.

When it is determined that operation of the compressor is in an abnormal state, the compressor may be stopped for a period of time and then started again. When the number of stops due to abnormal operation exceeds a predetermined number, the compressor may be stopped until an appropriate repair is carried out. Thus, air conditioning of the indoor space is stopped.

### BRIEF DESCRIPTION OF THE DRAWINGS

The embodiments will be described in detail with reference to the following drawings in which like reference numerals refer to like elements wherein:

FIG. 1 is a block diagram of an air conditioner according to an embodiment as broadly described herein.

FIG. 2 is a flowchart of a method of controlling an air conditioner according to an embodiment as broadly described herein.

FIGS. 3A-3B are graphs comparing frequencies of a compressor operating in a normal mode and in a safe mode according to an embodiment as broadly described herein.

### DETAILED DESCRIPTION

Reference will now be made in detail to the embodiments of the present disclosure, examples of which are illustrated in the accompanying drawings.

In the following detailed description, reference is made to the accompanying drawings that form a part hereof, and in which is shown by way of illustration exemplary embodiments. These drawings and the accompanying description thereof are provided in sufficient detail to enable those skilled in the art to practice these embodiments, and it is understood that other embodiments may be utilized and that logical structural, mechanical, electrical, and chemical changes may be made without departing from the spirit or scope as broadly described herein.

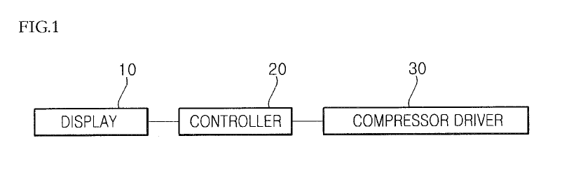

FIG. 1 is a block diagram of an exemplary air conditioner according to an embodiment as broadly described herein.

Referring to FIG. 1, the air conditioner may include a compressor driver 30 that drives a compressor, a controller that controls operation of the compressor driver 30 to vary a driving frequency of the compressor, and a display 20 that provides an indication if the compressor is in an abnormal state.

The controller 10 may check a difference between a sensed indoor temperature and a desired indoor temperature to control operation of the compressor driver 30 so that the frequency of the compressor may be varied. For example, during a heating operation of the air conditioner, the controller 10 may decrease the driving frequency of the compressor when the indoor temperature is greater than the desired temperature, and the controller 10 may increase the driving frequency of the compressor when the indoor temperature is less than the desired temperature.

When the driving frequency of the compressor exceeds a limit frequency, the controller 10 may stop operation of the compressor for a predetermined amount of time in order to prevent damage to the compressor. The controller 10 may cause the display 20 to operate when the air conditioner is operating in an abnormal state.

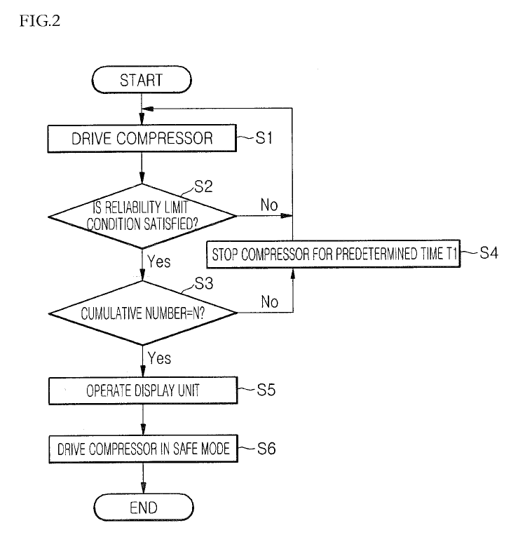

FIG. 2 is a flowchart of a method of controlling an air conditioner according to an embodiment as broadly described herein.

Referring to FIG. 2, in step S1, when the air conditioner operates in response to a user's selection, the compressor compresses a refrigerant.

In step S2, the controller 10 may determine whether a reliability limit condition of the air conditioner has been satisfied. The reliability limit condition may be an condition which may be detrimental to the reliability and/or continued operation of the compressor, for example, a condition in which operation of the air conditioner is outside of a normal state. For example, the controller 10 may determine whether a current frequency of the compressor is greater than the limit frequency. The controller 10 may also determine whether a predetermined current flows to the compressor, or whether a discharge temperature (or pressure) of the compressor is greater than a predetermined temperature (or pressure), or an excessive amount of frost accumulated by an evaporator.

In step S3, when the reliability limit condition has been satisfied, i.e., when the controller 10 determines that one or more of the exemplary conditions discussed above has been met/threshold(s) exceeded, the controller 10 may then determine whether a cumulative satisfaction number is equal to a number N for a reference time T2. More specifically, the controller 10 may determine whether the particular condition/threshold has been met/exceeded a predetermined number of times N or more during a predetermined period of time T2. For example, the controller 10 may determine whether the reliability limit condition has been satisfied 5 times or more during one hour (reference time: T2).

When it is determined in step S3 that the reliability limit condition has not been met/exceeded N times during the reference time T2, the controller 10 may control operation of the compressor driver 30 to stop the compressor for a predetermined time T1 in step S4. After the reference time T1 elapses, the controller 10 may control operation of the compressor driver 30 to resume operation of the compressor.

When it is determined in step S3 that the reliability limit condition has been met/exceeded N times during the reference time T2, the controller 10 may control operation of the display 20 to display the abnormal state of the air conditioner on the display 20 in step S5. In step S6, the controller 10 may control the compressor driver 30 to operate the compressor in a safe mode.

In this embodiment, the abnormal state of the air conditioner may mean that the reliability limit condition has been met/exceeded N or more times during the reference time T2. Before the reliability limit condition is met/exceeded N times during the reference time T2, whenever the reliability limit condition is satisfied, the controller 10 may control the compressor driver 30 so that the compressor stops for the predetermined time T1 and then operates again, as in step S4. In certain embodiments, when the reliability limit condition has been met/exceeded N times during the reference time T2, the compressor may stop for the predetermined time T1 before the compressor operates in the safe mode in step S6.

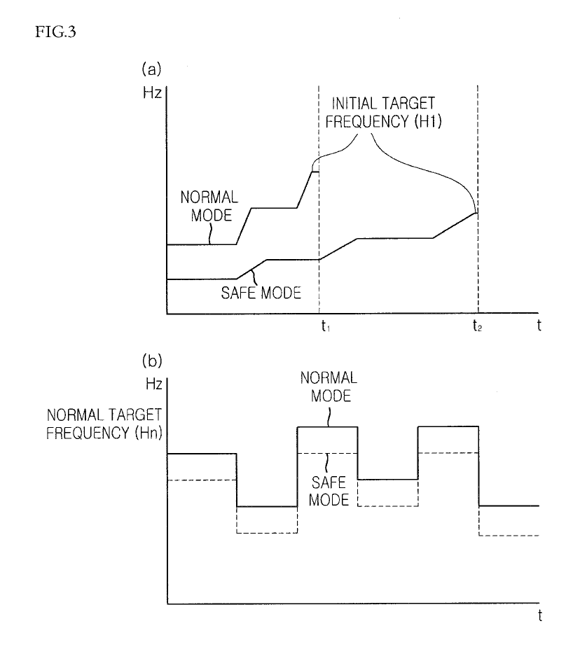

FIGS. 3A-3B are graphs comparing frequencies of a compressor operating in a normal mode and in a safe mode as described above. FIG. 3A illustrates frequencies in an initial operation mode of the compressor, and FIG. 3B illustrates desired frequencies in a main operation mode of the compressor.

The initial operation mode is a mode in which a preliminary operation to stably operate the compressor when the compressor is first operated is conducted.

Frequency variation in the initial operation mode of the compressor will now be described. When the compressor operates, a current frequency of the compressor increases in phases until the current frequency of the compressor reaches an initial target frequency H1.

When the compressor operates in the safe mode, the magnitude of the frequency and/or the rate at which the frequency increases in a particular phase may be lower, thus increasing the time required for the frequency to reach a desired level when compared to the normal mode. Thus, a time t2 for the current frequency of the compressor to reach the target frequency in the safe mode is greater than a time t1 that it takes to reach the target frequency in the normal mode.

Also, the initial target frequency of the compressor in the safe mode may be set lower than that of the compressor in the normal mode.

When the current frequency of the compressor reaches the initial target frequency H1, the compressor may operate in a main operation mode.

When the compressor operates in a main operation mode, the controller 10 may sense a difference between an actual indoor temperature and a desired indoor temperature so as to continuously set a normal target frequency Hn, and may control operation of the compressor driver 30 so as to operate the compressor with the set normal target frequency Hn.

When the compressor operates in the safe mode, the controller 10 may set the target frequency lower than the normal target frequency in the normal mode to drive the compressor, as illustrated in FIG. 3B. Even when the compressor operates in the safe mode, it may still be determined whether the reliability limit condition is met. When the compressor operates in the safe mode, the limit frequency of the compressor may be set lower than that of the compressor when the compressor operates in the normal mode.

In an air conditioner as embodied and broadly described herein, even when the air conditioner is operating in an abnormal state, the compressor can operate in the safe mode. Thus, the air conditioning of indoor space may be continuously performed.

When the air conditioner is operating in the abnormal state, the compressor may operate in the safe mode to perform the air conditioning of the indoor space while minimizing damage to the air conditioner.

When the compressor operates in the safe mode, the display may display an indication of the abnormal state of the air conditioner. Thus, a user can easily recognize operation of the air conditioner in the abnormal state.

A method of controlling an air conditioner is provided.

In one embodiment, a method of controlling an air conditioner may include determining whether the air conditioner is in an abnormal state while the air conditioner operates; and operating, when the air conditioner is in the abnormal state, a compressor with a frequency pattern in a safe mode different from a frequency pattern in a normal mode of the compressor.

In another embodiment, a method of controlling an air conditioner may include operating a compressor; determining whether a reliability limit condition of the air conditioner is satisfied during the operating of the compressor; determining whether a cumulative number reaches a predetermined number N of times, when the reliability limit condition of the air conditioner is satisfied; and controlling the operating of the compressor according to the determining of the cumulative number, wherein when the cumulative number is less than the number N, the compressor is stopped for a predetermined time, and then is operated again, and when the cumulative number is greater than the number N, the compressor operates with an operation pattern in a safe mode different from an operation pattern in a normal mode of the compressor.

Any reference in this specification to “one embodiment,” “an embodiment,” “example embodiment,” “certain embodiment,” “alternative embodiment,” etc., means that a particular feature, structure, or characteristic described in connection with the embodiment is included in at least one embodiment as broadly described herein. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, numerous variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method of controlling an air conditioner, the method comprising:
operating a compressor of the air conditioner in a normal mode having a first frequency pattern and determining whether the air conditioner is in an abnormal state as the air conditioner operates; and
operating the compressor in a safe mode having a second frequency pattern that is different from the first frequency pattern when it is determined that the air conditioner is in an abnormal state.

2. The method of claim 1, wherein the determining whether the air conditioner is in a abnormal state comprises determining whether a reliability limit condition has been met, comprising:
determining whether an operation frequency of the compressor has reached a predetermined limit frequency, or determining whether a current applied to the compressor has reached a predetermined current.

3. The method of claim 2, further comprising determining whether a number of times the reliability limit condition has been met is greater than or equal to a predetermined number of times during a reference time period.

4. The method of claim 3, wherein, when the number of times the reliability limit condition has been met during the reference time period is greater than zero and less than the predetermined number of times, the method further comprises stopping the compressor for a predetermined amount of time and then resuming operation of the compressor after the predetermined amount of time has elapsed, and when the number of times the reliability limit condition has been met during the reference time period is greater than or equal to the predetermined number of times, the method further comprises operating the compressor in the safe mode.

5. The method of claim 1, wherein the compressor has a plurality of operation modes, including an initial operation mode during which an operating frequency is increased, and a main operation mode which is performed after the initial operation mode has been completed.

6. The method of claim 5, further comprising changing an operation mode of the compressor from the initial operation mode to the main operation mode when the frequency of the compressor in the initial operation mode reaches an initial target frequency.

7. The method of claim 6, wherein an initial operation time corresponding to the initial operation mode when the compressor operates in the safe mode is greater than an initial operation time corresponding to the initial operation mode when the compressor operates in the normal mode.

8. The method of claim 6, wherein a magnitude of frequency in the safe mode is less than an amount of frequency variation in the normal mode.

9. The method of claim 6, wherein a duration of frequency variation in the safe mode is greater than a duration of frequency variation in the normal mode.

10. The method of claim 4, wherein a target frequency of the compressor in the safe mode is less than a target frequency of the compressor in the normal mode.

11. The method of claim 1, further comprising displaying the abnormal state of the air conditioner on a display while the compressor operates in the safe mode.

12. A method of controlling an air conditioner, the method comprising:
operating a compressor;
determining whether a reliability limit condition of the air conditioner has been met while operating of the compressor;
determining whether a cumulative number of times the reliability limit condition has been met is greater than or equal to a predetermined number of times; and
controlling operation of the compressor based on the cumulative number of times the reliability limit condition has been met.

13. The method of claim 12, wherein controlling operation of the compressor based on the cumulative number of times the reliability limit condition has been met comprises:
when the cumulative number of times the reliability condition has been met is less than the predetermined number of times, stopping the compressor is stopped for a predetermined amount of time, and then resuming operation of the compressor after the predetermined amount of time has elapsed; and
when the cumulative number of times that the reliability limiting condition has been met is greater than or equal to the predetermined number of times, operating the compressor in a safe mode having an operation pattern that is different from an operation pattern of the compressor in a normal mode.

14. The method of claim 13, wherein a speed or a size of frequency variation of the compressor in the safe mode is less than a speed or a size of frequency variation of the compressor in the normal mode.

15. The method according to claim 13, wherein a duration of frequency variation in the safe mode is greater than a duration of frequency variation in the normal mode.

16. The method of claim 13, wherein a target frequency or a limit frequency of the compressor in the safe mode is set lower than a target frequency or a limit frequency in the normal mode.
